(19) United States
(12) Patent Application Publication
(10) Pub. No.: US 2025/0300379 A1
(43) Pub. Date: Sep. 25, 2025

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Pipatthana PHATIWUTTIPAT, Mie (JP)

(21) Appl. No.: 18/859,171

(22) PCT Filed: Apr. 10, 2023
(86) PCT No.: PCT/JP2023/014518

§ 371 Date: Oct. 23, 2024

(30) Foreign Application Priority Data
Apr. 27, 2022 (JP) 2022-073388

(51) Int. Cl. H01R 12/77

(52) U.S. Cl. CPC H01R 12/774

(57) ABSTRACT

A connector (10) includes a housing (20) and a flexible cable (30) to be assembled with the housing (20). The housing includes a boss pin (52) to be assembled with the flexible cable (30). The flexible cable (30) includes a body portion (31), a first constituent portion (60) protruding in a direction toward a tip from the body portion (31), electrically conductive paths being routed in the first constituent portion (60), and a second constituent portion (70) protruding in the direction toward the tip from the body portion (31) and to be assembled with the boss pin (52). The boss pin (52) includes a column portion (53). A coupled state of the boss pin (52) and the body portion (31) is released by breaking the column portion (53).

### TECHNICAL FIELD

The present disclosure relates to a connector.

### BACKGROUND

Patent Document 1 discloses a connector in which a flexible cable is mounted on a housing. A plurality of terminal fittings connected to an end part of the flexible cable are accommodated in the housing. Reinforcement holes provided in the flexible cable are fit to boss pins provided on the housing, whereby a position shift of the flexible cable with respect to the housing is prevented.

### PRIOR ART DOCUMENT

### Patent Document

Patent Document 1: International Publication No. WO 2019/188738

### SUMMARY OF THE INVENTION

### Problems to be Solved

If a tensile force acts on the flexible cable in the configuration of the connector as disclosed in Patent Document 1, it is supposed that a load is applied to a part of the flexible cable where electrically conductive paths are provided. Accordingly, a configuration is required which can confirm an extent of a load generated in the part of the flexible cable where the electrically conductive paths are provided.

The present disclosure was completed on the basis of the above situation and can confirm an extent of a load generated in a part of a flexible cable where electrically conductive paths are provided.

### Means to Solve the Problem

The present disclosure is directed to a connector with a housing and a flexible cable to be assembled with the housing, the housing including a boss pin to be assembled with the flexible cable, the flexible cable including a body portion, a first constituent portion protruding in a direction toward a tip from the body portion, electrically conductive paths being routed in the first constituent portion, and a second constituent portion protruding in the direction toward the tip from the body portion, the second constituent portion being assembled with the boss pin, at least one of the boss pin and the second constituent portion being provided with a breaking portion, and a coupled state of the boss pin and the body portion being released by breaking the breaking portion.

### Effect of the Invention

According to the present disclosure, it is possible to confirm an extent of a load generated in a part of a flexible cable where electrically conductive paths are provided.

### BRIEF DESCRIPTION OF THE DRAWINGS

FIG. 1 is a perspective view of a connector according to a first embodiment.

FIG. 2 is an exploded perspective view of the connector.

FIG. 3 is a perspective view of a flexible cable when viewed from below.

FIG. 4 is a side view of the connector.

FIG. 5 is a side view in section showing a cut surface passing through a right boss pin.

FIG. 6 is a side view in section showing a cut surface passing through a left boss pin.

FIG. 7 is a perspective view of a connector according to a second embodiment.

FIG. 8 is a perspective view enlargedly showing a second constituent portion on a right side of FIG. 7.

FIG. 9 is a plan view schematically showing a second constituent portion of a connector according to another embodiment.

FIG. 10 is a plan view schematically showing a second constituent portion different from that of FIG. 9 according to another embodiment.

### DETAILED DESCRIPTION TO EXECUTE THE INVENTION

### Description of Embodiments of Present Disclosure

Embodiments of the present disclosure are listed and described below.

[1] The connector is provided with a housing and a flexible cable to be assembled with the housing, the housing including a boss pin to be assembled with the flexible cable, the flexible cable including a body portion, a first constituent portion protruding in a direction toward a tip from the body portion, electrically conductive paths being routed in the first constituent portion, and a second constituent portion protruding in the direction toward the tip from the body portion, the second constituent portion being assembled with the boss pin, at least one of the boss pin and the second constituent portion being provided with a breaking portion, and a coupled state of the boss pin and the body portion being released by breaking the breaking portion.

In the connector of [1] described above, such as when a tensile force acts on the second constituent portion due to the action of a tensile force on the body portion of the flexible cable or the like, the breaking portion provided in at least one of the boss pin and the second constituent portion can be broken. Since the coupled state of the boss pin and the body portion is released by breaking the breaking portion, it can be confirmed that a certain load is generated in a part of the flexible cable where the electrically conductive paths are provided by grasping the release of such a coupled state.

[2] In the connector of [1] described above, the breaking portion is provided in the second constituent portion.

In the connector of [2] described above, the boss pin is less likely to be fragmented as compared to a configuration in which the breaking portion is provided in the boss pin and the boss pin is broken.

[3] In the connector of [2] described above, the breaking portion is configured as a narrow portion narrower than parts of the second constituent portion other than the breaking portion.

In the connector of [3] described above, the narrow portion narrower than the parts of the second constituent portion other than the breaking portion is easily broken. Thus, the breakage of the breaking portion is easily specified by focusing on the narrow portion to grasp the release of the coupled state between the boss pin and the body portion.

[4] In the connector of [2] described above, the second constituent portion is provided with a locking hole to be locked to the boss pin, and the breaking portion is a part including a hole edge part of the locking hole, out of the second constituent portion.

In the connector of [4] described above, the breaking strength of the breaking portion can be adjusted by changing the positions of the boss pin and the locking hole.

[5] In the connector of [1] described above, the breaking portion is provided in the boss pin.

In the connector of [5] described above, the breaking strength of the breaking portion can be changed by changing the shape of the boss pin, and the breaking strength of the breaking portion is easily adjusted.

[6] In the connector of any one of [1] to [5] described above, the electrically conductive paths are arranged in parallel in the first constituent portion, and a pair of the second constituent portions are arranged on both sides across the first constituent portion in a parallel direction of the electrically conductive paths.

In the connector of [6] described above, even if a tensile force biased toward one side in the parallel direction of the electrically conductive paths is applied in the flexible cable, the release of the coupled state of the boss pin and the body portion can be confirmed by properly breaking the breaking portion on the side of either one of the second constituent portions.

### DETAILS OF EMBODIMENTS OF PRESENT DISCLOSURE

### First Embodiment

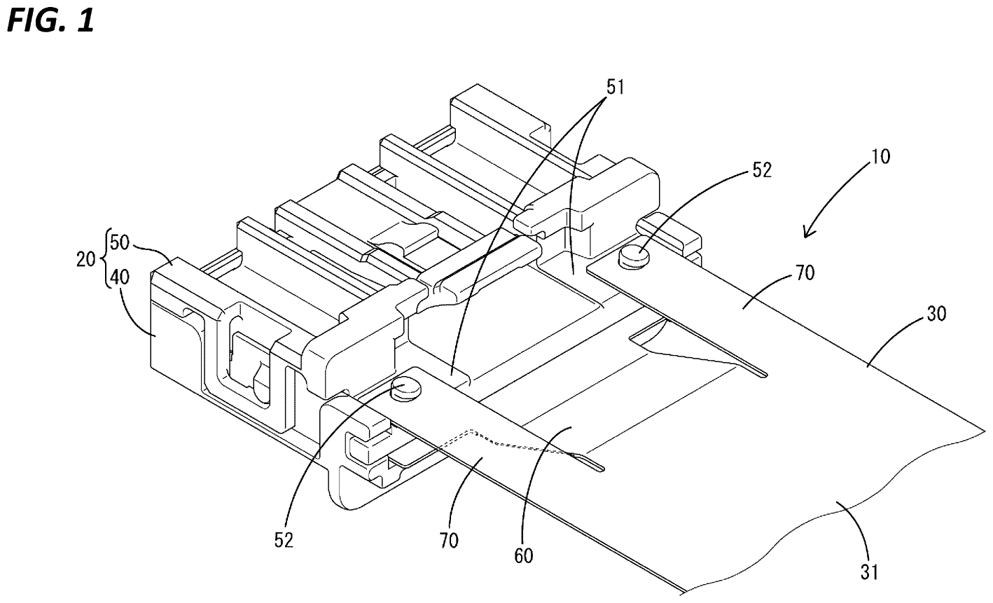

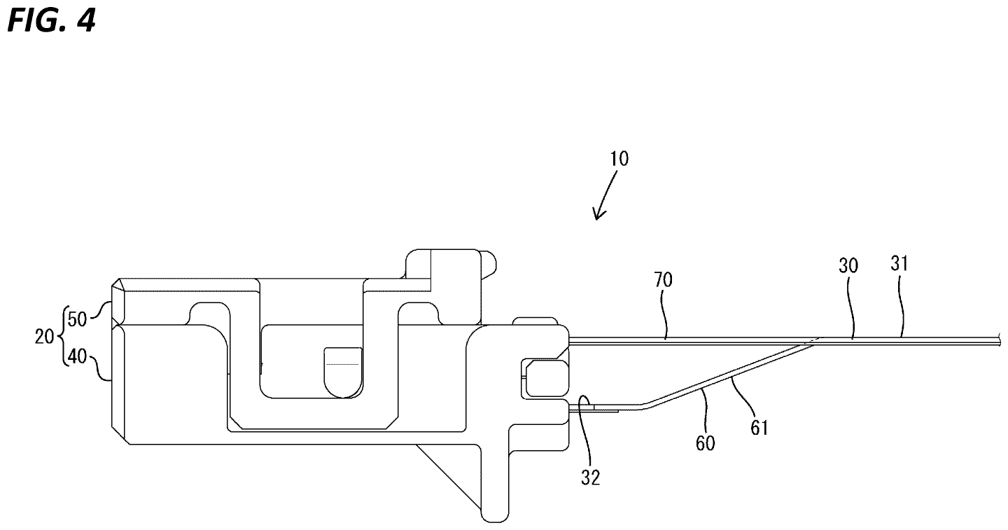

A specific first embodiment of a connector of the present disclosure is described with reference to FIGS. 1 to 6. Note that the present invention is not limited to these illustrations, but is represented by claims and intended to include all changes in the scope of claims and in the meaning and scope of equivalents. In the first embodiment, left and right sides in FIGS. 4 to 6 are defined as front and rear sides concerning a front-rear direction. Upper and lower sides shown in FIGS. 4 to 6 are directly defined as upper and lower sides concerning a vertical direction. An oblique right upper side and an oblique left lower side in FIG. 1 are defined as left and right sides concerning a lateral direction.

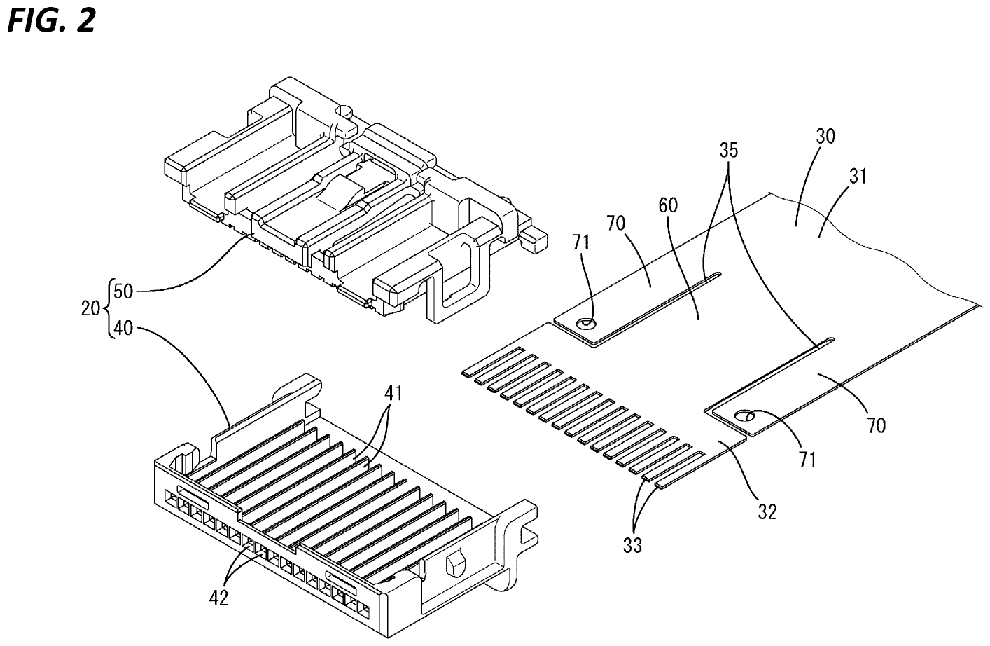

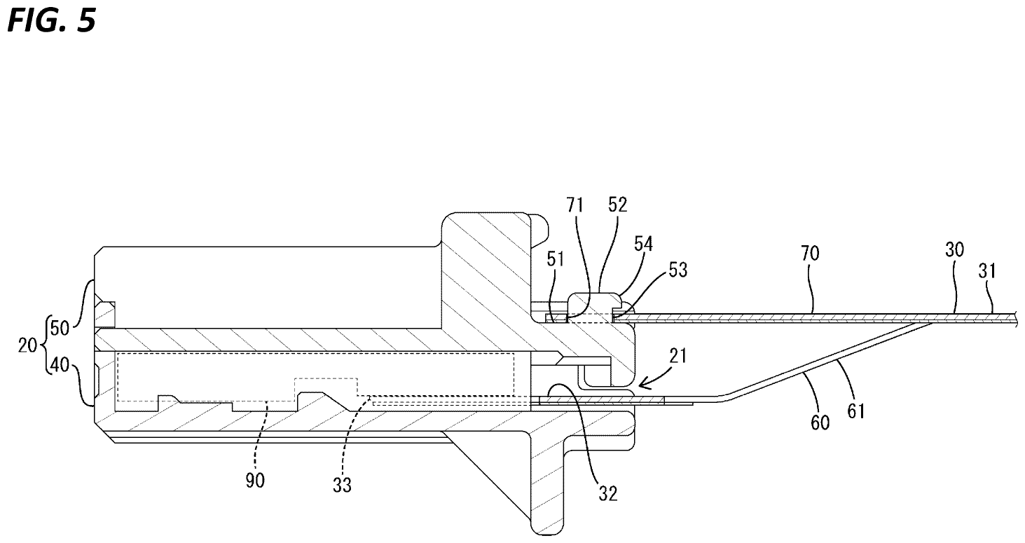

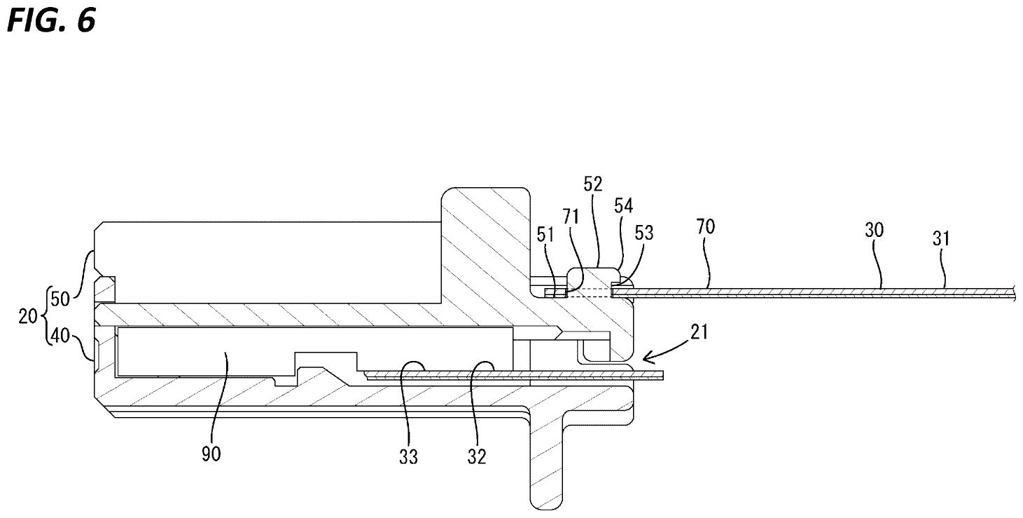

As shown in FIGS. 1 and 2, a connector 10 of the first embodiment is provided with a housing 20, a flexible cable 30 and terminal fittings 90 (see FIGS. 5 and 6). The flexible cable 30 is connected to the terminal fittings 90 (see FIGS. 5 and 6) and assembled with the housing 20.

The housing 20 includes a lower housing 40 and an upper housing 50. The housing 20 is configured by uniting the lower housing 40 and the upper housing 50 with each other.

The lower housing 40 is made of synthetic resin. As shown in FIG. 2, the lower housing 40 has a flat shape long in the lateral direction. The lower housing 40 is provided with a plurality of terminal accommodation recesses 41. The terminal accommodation recess 41 is shaped to be long in the front-rear direction. The plurality of terminal accommodation recesses 41 are arranged in parallel in the lateral direction. A plurality of terminal insertion holes 42 penetrating in the front-rear direction are respectively provided to correspond to the plurality of terminal accommodation recesses 41 in the front end of the lower housing 40.

The upper housing 50 is made of synthetic resin. As shown in FIG. 2, the upper housing 50 has a flat shape long in the lateral direction. As shown in FIG. 1, a pair of left and right flat portions 51 are provided on a rear end side of the upper surface of the upper housing 50. The flat portion 51 has a horizontal exposed surface facing upward. The flat portion 51 is provided with a boss pin 52. A pair of left and right boss pins 52 are disposed at positions overlapping in the lateral direction in the upper housing 50. The boss pins 52 are exposed to outside.

As shown in FIG. 1, the boss pins 52 are assembled with the flexible cable 30. The boss pin 52 projects upward from the exposed surface of the flat portion 51. As shown in FIG. 5, the boss pin 52 includes a column portion 53 and an extending portion 54. The column portion 53 has a cylindrical shape extending upward from the flat portion 51. The extending portion 54 extends rearward from the tip of the column portion 53. The tip of the extending portion 54 has a curved shape convex rearward in a plan view. The lower surface of the extending portion 54 is a horizontal surface.

As shown in FIG. 5, the housing 20 is provided with a slit-like opening 21 configured by the rear end of the lower housing 40 and the rear end of the upper housing 50. The opening 21 has a shape elongated in the lateral direction. A connecting end part 32 of the flexible cable 30 to be described later is inserted into the opening 21. In the housing 20, the flat portions 51 and the boss pins 52 are provided above the opening 21 (on the side of the upper housing 50).

The flexible cable 30 is such that electrically conductive paths and circuits are formed on a base film, which is a flexible and thin film-like insulator. Specific examples of the flexible cable 30 include flexible printed circuits, flexible flat cables and the like. The plurality of terminal fittings 90 are connected to a front end part of the flexible cable 30 by welding or the like.

The flexible cable 30 includes a body portion 31, a first constituent portion 60, a pair of second constituent portions 70 and the connecting end part 32. The body portion 31 constitutes a part on a rear end side (side opposite to a part connected to the terminal fittings 90) of the flexible cable 30. The electrically conductive paths (not shown) are routed in the body portion 31.

As shown in FIG. 2, the first constituent portion 60 protrudes in a direction toward a tip (forward) from the body portion 31 in a state before being assembled with the housing 20. The electrically conductive paths (not shown) are routed in the first constituent portion 60. For example, a plurality of the electrically conductive paths (not shown) are routed to extend along the front-rear direction in the first constituent portion 60. The plurality of the electrically conductive paths (not shown) routed in the first constituent portion 60 are arranged in parallel in the lateral direction.

The connecting end part 32 protrudes in the direction toward the tip (forward) from the first constituent portion 60. The connecting end part 32 is wider in the lateral direction than the first constituent portion 60. A lateral width of the connecting end part 32 is equal to that of a part of the flexible cable 30 where the first constituent portion 60 and the pair of second constituent portions 70 are arranged. A plurality of tip parts 33 in the form of comb-teeth are provided in the tip of the connecting end part 32. The terminal fittings 90 are connected to the tip parts 33.

As shown in FIG. 2, the pair of second constituent portions 70 protrude in the direction toward the tip (forward) from the body portion 31 while being arranged side by side with the first constituent portion 60 in the lateral direction in the state before being assembled with the housing 20. The pair of second constituent portions 70 are disposed on both left and right sides of the first constituent portion 60. No electrically conductive paths are routed in the second constituent portions 70. The second constituent portions 70 are assembled with the boss pins 52.

The second constituent portions 70 are provided with a pair of locking holes 71 to be respectively locked to the pair of boss pins 52. The locking hole 71 is provided in the tip (front end) of the second constituent portion 70.

The body portion 31, the first constituent portion 60, the pair of second constituent portions 70 and the connecting end part 32 can be formed by forming a pair of L-shaped cuts 35 in the rectangular flexible cable. The pair of second constituent portions 70 are arranged on both sides across the first constituent portion 60 in a parallel direction (lateral direction) of the electrically conductive paths (not shown) of the first constituent portion 60 in the state before being assembled with the housing 20. The first constituent portion 60 and the second constituent portions 70 are spaced apart. The first constituent portion 60 and the second constituent portions 70 are arranged in parallel to be individually expandable and contractible. Thus, such as when a tensile force acts on the second constituent portion 70 due to the action of a tensile force on the body portion 31 or the like, a tensile force is hardly generated in the first constituent portion 60 and a load generated in the electrically conductive paths provided in the first constituent portion 60 can be effectively suppressed.

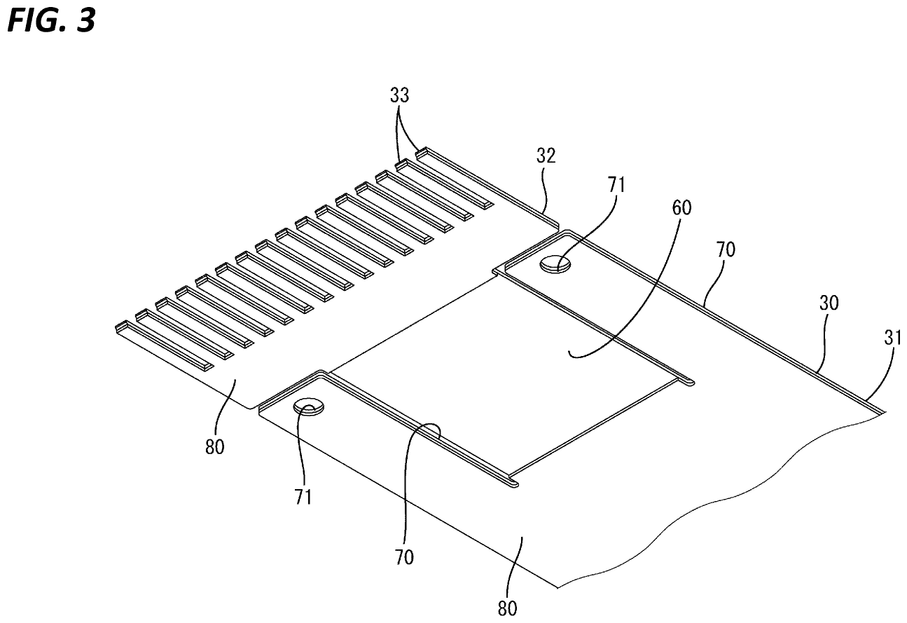

As shown in FIG. 3, reinforcement plates 80 are provided in parts of the flexible cable 30 except the first constituent portion 60. That is, the reinforcement plates 80 are provided on the body portion 31, the pair of second constituent portions 70 and the connecting end part 32. The reinforcement plates 80 are disposed on the respective lower surfaces of the body portion 31, the pair of second constituent portions 70 and the connecting end part 32.

The column portion 53 of the boss pin 52 corresponds to an example of a “breaking portion” of the present disclosure. By breaking the column portion 53, an assembled state of the boss pin 52 and the second constituent portion 70 is released and a coupled state of the boss pin 52 and the body portion 31 is released. The boss pin 52 is broken, for example, by pulling the second constituent portion 70 rearward to vertically divide the column portion 53.

Such as when a tensile force acts on the second constituent portion 70 due to the action of a tensile force on the body portion 31 of the flexible cable 30 or the like, the column portion 53 of the boss pin 52 can be broken. Since the coupled state of the boss pin 52 and the body portion 31 is released by breaking the boss pin 52, it can be confirmed that a certain load (e.g. a load of such an extent as to guarantee the strength of the electrically conductive paths) is generated in the part of the flexible cable 30 where the electrically conductive paths are provided by grasping the release of such a coupled state.

The breaking strength of the column portion 53 can be adjusted, for example, by changing a diameter of the column portion 53. For example, the breaking strength of the column portion 53 increases as the diameter of the column portion 53 increases. The breaking strength of the column portion 53 decreases as the diameter of the column portion 53 decreases. Therefore, the shape of the column portion 53 is easily designed.

Next, an assembly process of the connector 10 is described. First, the connecting end part 32 of the flexible cable 30 connected to the terminal fittings 90 is arranged in the lower housing 40. Subsequently, the upper housing 50 is assembled with the lower housing 40. In this way, the housing 20 is formed and the plurality of tip parts 33 of the connecting end part 32 and the terminal fittings 90 are accommodated in the housing 20. The rear end of the connecting end part 32 and the first and second constituent portions 60, 70 are located behind the opening 21 of the housing 20.

Subsequently, as shown in FIGS. 5 and 6, the locking holes 70 of the pair of second constituent portions 70 are respectively locked to the pair of boss pins 52. As shown in FIGS. 5 and 6, the plate surfaces of the pair of second constituent portions 70 are horizontally held and located on the same plane as the body portion 31. The pair of second constituent portions 70 are not bent. The first constituent portion 60 is disposed to be lower than the body portion 31 and the second constituent portions 70. Steps are configured by the first and second constituent portions 60, 70. The first constituent portion 60 includes a bent portion 61 bent with respect to the body portion 31 with the second constituent portions 70 assembled with the boss pins 52. Specifically, the bent portion 61 is inclined downward toward the front.

As shown in FIGS. 5 and 6, the connecting end part 32 is arranged to be lower than the body portion 31 and the second constituent portions 70. The plate surface of the connecting end part 32 is disposed in parallel to that of the body portion 31 and those of the second constituent portions 70.

As described above, in the connector 10 of the present disclosure, the boss pin 52 is provided with the column portion 53, which is an example of the “breaking portion” of the present disclosure. The coupled state of the boss pin 52 and the body portion 31 is released by breaking the column portion 53. In this way, the column portion 53 of the boss pin 52 can be broken such as when a tensile force acts on the second constituent portion 70 due to the action of a tensile force on the body portion 31 of the flexible cable 30 or the like. Since the coupled state of the boss pin 52 and the body portion 31 is released by breaking the boss pin 52, it can be confirmed that a certain load is generated in the part of the flexible cable 30 where the electrically conductive paths are provided by grasping the release of such a coupled state.

Further, in the connector 10 of the present disclosure, the “breaking portion” of the present disclosure is provided in the boss pin 52. In this way, the breaking strength of the boss pin 52 can be changed by changing the shape of the boss pin 52, and the breaking strength of the boss pin 52 is easily adjusted.

Further, in the connector 10 of the present disclosure, the electrically conductive paths are arranged in parallel in the first constituent portion 60. The pair of second constituent portions 70 are arranged on the both sides across the first constituent portion 60 in the parallel direction of the electrically conductive paths. In this way, even if a tensile force biased toward one side in the parallel direction of the electrically conductive paths is applied in the flexible cable 30, the release of the coupled state of the boss pin 52 and the body portion 31 can be confirmed by properly breaking the boss pin 52 on the side of either one of the second constituent portions 70.

### Second Embodiment

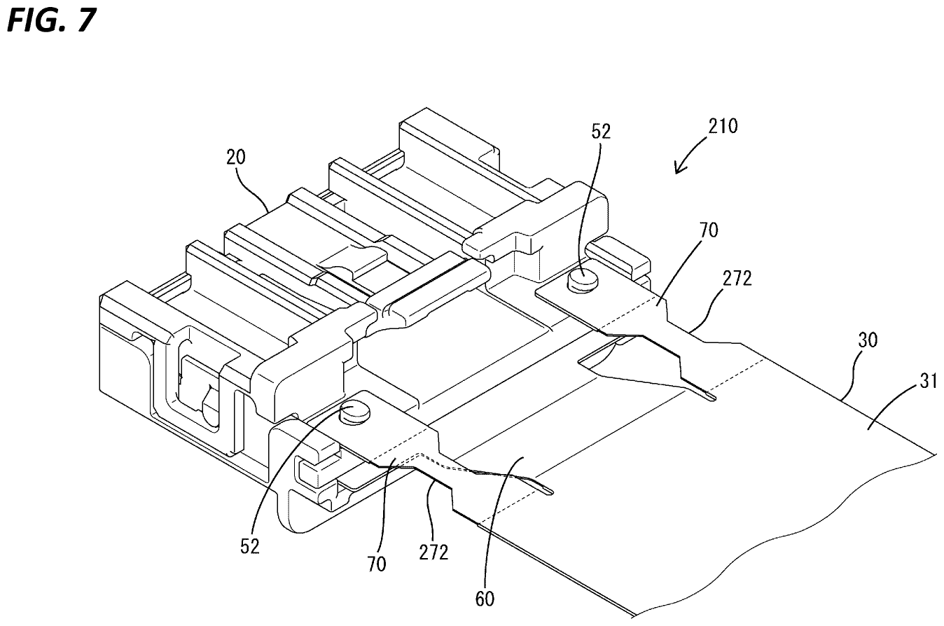

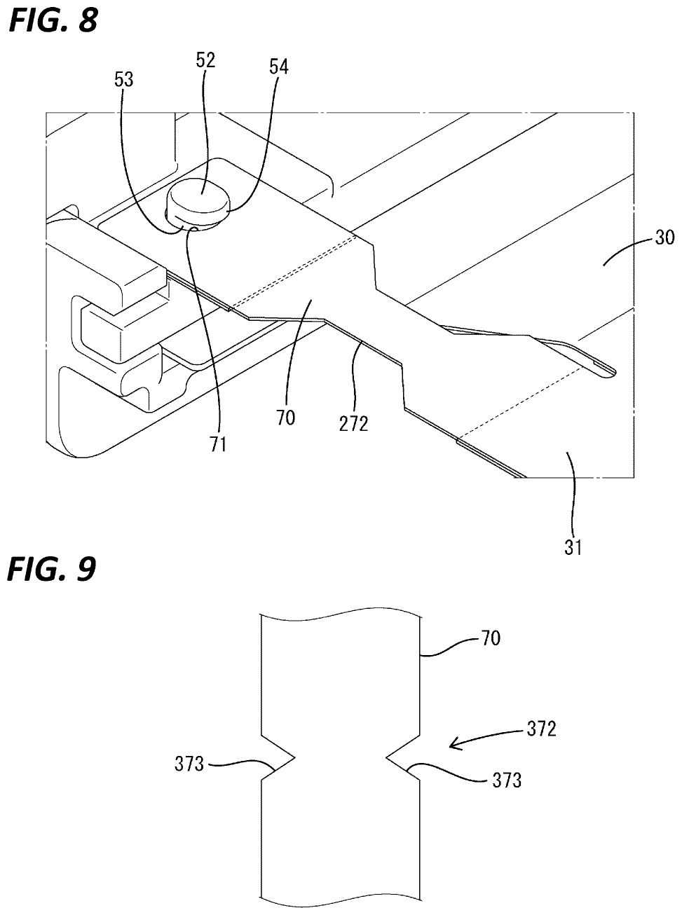

FIGS. 7 and 8 are views showing a connector of a second embodiment. The second embodiment differs from the first embodiment in the configuration of the breaking portions. The other configuration is the same as in the first embodiment and not described in detail.

A connector 210 of the second embodiment embodying the connector of the present disclosure is described with reference to FIGS. 7 and 8. In the connector 210 of the second embodiment, a second constituent portion 70 includes a narrow portion 272 as shown in FIGS. 7 and 8. The narrow portion 272 has a lateral width smaller than parts of the second constituent portion 70 other than the narrow portion 272 (parts in front of, behind and adjacent to the narrow portion 272). The narrow portion 272 corresponds to an example of the “breaking portion” of the present disclosure. The narrow portion 272 is provided between a locking hole 71 and a body portion 31 in the second constituent portion 70.

The narrow portion 272 narrower than the parts of the second constituent portion 70 other than the narrow portion 272 is easily broken. Thus, the breakage of the second constituent portion 70 is easily specified by focusing on the narrow portion 272 to grasp the release of a coupled state between a boss pin 52 and the body portion 31.

### OTHER EMBODIMENTS

The present invention is not limited to the above described and illustrated embodiments, but is represented by claims. The present invention is intended to include all changes in the scope of claims and in the meaning and scope of equivalents and also include the following embodiments.

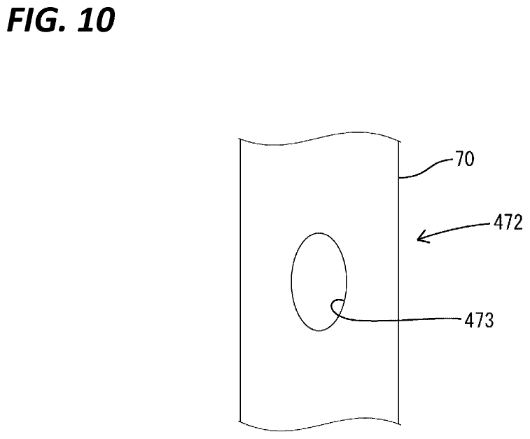

Although the narrow portion 272 of the second constituent portion 70 is illustrated as an example of the “breaking portion” of the present disclosure in the above second embodiment, a part having another shape may be the “breaking portion” of the present disclosure. For example, as shown in FIG. 9, a narrow portion 372 including a pair of cuts 373 provided in the second constituent portion 70 may be the “breaking portion” of the present disclosure. For example, as shown in FIG. 10, a narrow portion 472 including a pair of through holes 473 provided in the second constituent portion 70 may be the “breaking portion” of the present disclosure. For example, the second constituent portion 70 having a constant width may be the “breaking portion” of the present disclosure as in the above first embodiment.

Although the column portion 53 of the boss pin 53 is disclosed to correspond to an example of the “breaking portion” of the present disclosure in the above first embodiment, a part of the second constituent portion 70 including a hole edge part of the locking hole 71 may correspond to an example of the “breaking portion” of the present disclosure. In this way, the breaking strength of the breaking portion (part including the hole edge part of the locking hole 71) can be adjusted by changing the positions of the boss pin 52 and the locking hole 71. For example, by forming the locking hole 71 near the tip of the second constituent portion 70, a tip side from the locking hole 71 is easily cracked.

Although the second constituent portion 70 is integrally configured to the body portion 31 in the above embodiment, the second constituent portion 70 may be a member separate from the body portion 31 and assembled with the body portion 31.

Although the housing 20 has a split structure composed of the lower housing 40 and the upper housing 50 in the above first embodiment, the housing 20 may be integrally configured.

Although the tip (extending portion 54) of the boss pin 52 is shaped to protrude rearward in the above first embodiment, the tip may have an umbrella-shape protruding entirely about an axis.

### LIST OF REFERENCE NUMERALS

List of Reference Numerals

| | |
|---|---|
| 10 | connector |
| 20 | housing |
| 21 | opening |
| 30 | flexible cable |
| 31 | body portion |
| 32 | connecting end part |
| 33 | tip part |
| 35 | cut |
| 40 | lower housing |
| 41 | terminal accommodation recess |
| 42 | terminal insertion hole |
| 50 | upper housing |
| 51 | flat portion |
| 52 | boss pin |
| 53 | column portion (breaking portion) |
| 54 | extending portion |
| 60 | first constituent portion |
| 61 | bent portion |
| 70 | second constituent portion |
| 71 | locking hole |
| 80 | reinforcement plate |
| 90 | terminal fitting |
| 210 | connector |
| 272 | narrow portion (breaking portion) |
| 372 | narrow portion (breaking portion) |
| 373 | cut |
| 472 | narrow portion (breaking portion) |
| 473 | through hole |

1. A connector, comprising:
a housing; and
a flexible cable to be assembled with the housing,
the housing including a boss pin to be assembled with the flexible cable,
the flexible cable including:
a body portion;
a first constituent portion protruding in a direction toward a tip from the body portion, electrically conductive paths being routed in the first constituent portion; and
a second constituent portion protruding in the direction toward the tip from the body portion, the second constituent portion being assembled with the boss pin,
at least one of the boss pin and the second constituent portion being provided with a breaking portion, and
a coupled state of the boss pin and the body portion being released by breaking the breaking portion.

2. The connector of claim 1, wherein the breaking portion is provided in the second constituent portion.

3. The connector of claim 2, wherein the breaking portion is configured as a narrow portion narrower than parts of the second constituent portion other than the breaking portion.

4. The connector of claim 2, wherein:
the second constituent portion is provided with a locking hole to be locked to the boss pin, and
the breaking portion is a part including a hole edge part of the locking hole, out of the second constituent portion.

5. The connector of claim 1, wherein the breaking portion is provided in the boss pin.

6. The connector of claim 1, wherein:
the electrically conductive paths are arranged in parallel in the first constituent portion, and
a pair of the second constituent portions are arranged on both sides across the first constituent portion in a parallel direction of the electrically conductive paths.
